(19) United States
(12) Patent Application Publication
(10) Pub. No.: US 2026/0196743 A1
(43) Pub. Date: Jul. 9, 2026

(54) IDC Terminal

(71) Applicant: Tyco Electronics AMP Korea Co., Ltd., Gyeongsan (KR)

(72) Inventors: Suk-Eun Jung, Gyeongsan-Si (KR); Sung-Chul Kim, Gyeongsan-Si (KR); Ki Deok Cheon, Gyeongsan-Si (KR); Byung-Hee Cho, Gyeongsan-Si (KR)

(73) Assignee: Tyco Electronics AMP Korea Co., Ltd., Gyeongsan (KR)

(21) Appl. No.: 19/444,361

(22) Filed: Jan. 9, 2026

(30) Foreign Application Priority Data
Jan. 9, 2025 (KR) 10-2025-0003420
Jan. 9, 2025 (KR) 30-2025-0001196
Dec. 31, 2025 (KR) 10-2025-0215711

(51) Int. Cl. H01R 4/02; H01R 4/2416

(52) U.S. Cl. CPC H01R 4/023; H01R 4/2416

(57) ABSTRACT

An insulation displacement contact (IDC) terminal for electrical connection with a magnet wire includes a solder tab, a solder post and a protrusion. The solder tab is coupled to a printed circuit board (PCB) of an installation target device. The solder post is inserted into a terminal block for coupling the magnet wire. The protrusion is formed to protrude outward at a boundary portion between the solder tab and the solder post. The solder post has an IDC slot adapted to be coupled to the magnet wire along a direction in which the IDC terminal is inserted into the terminal block, as well as a plurality of notches formed on both side portions of a region adjacent to the protrusion to be secured to an inner surface of the terminal block.

### CROSS-REFERENCE TO RELATED APPLICATION

This application claims the benefit of Korean Patent Application Nos. 10-2025-0003420 and 30-2025-0001196, each filed on Jan. 9, 2025, and Korean Patent Application No. 10-2025-0215711, filed on Dec. 31, 2025, in the Korean Intellectual Property Office, the entire disclosures of which are incorporated herein by reference for all purposes.

### FIELD OF THE INVENTION

The disclosure relates to an insulation displacement contact (IDC) terminal for connection with a magnet wire.

### BACKGROUND OF THE INVENTION

In the prior art, as the number of electrical devices in use increases, the use of small electric motors is also increasing. Such motors are typically provided in devices such as vacuum cleaners, kitchen appliances, and other arbitrary power accessories used in homes or businesses. To connect these motors, a magnet wire is typically connected to a terminal having an insulation displacement slot, such as a terminal of the Mag-Mate electrical connector owned by the present applicant. Conventionally, the magnet wire is connected to the terminal using a fusing technique and is soldered to a printed circuit board (PCB) by an overmolding method. However, in the connection method between the conventional magnet wire and the terminal, it is difficult to inspect the soldering quality of the magnet wire after fusing. In addition, there is an issue in that the soldering quality deteriorates after inspection of the soldering of the conventional magnet wire.

### SUMMARY OF THE INVENTION

According to an embodiment of the present disclosure, an insulation displacement contact (IDC) terminal for electrical connection with a magnet wire includes a solder tab, a solder post and a protrusion. The solder tab is coupled to a PCB of an installation target device. The solder post is inserted into a terminal block for coupling the magnet wire. The protrusion is formed to protrude outward at a boundary portion between the solder tab and the solder post. The solder post has an IDC slot formed to be coupled to the magnet wire along a direction in which the IDC terminal is inserted into the terminal block, as well as a plurality of notches formed on both side portions of a region adjacent to the protrusion to be secured to an inner surface of the terminal block.

### BRIEF DESCRIPTION OF DRAWINGS

The above and other features of the present invention will become more apparent by describing in detail exemplary embodiments thereof with reference to the accompanying drawings, in which:

FIG. 1 is a perspective view illustrating a state in which an IDC terminal is installed according to an embodiment of the present disclosure;

FIG. 2 is a perspective view illustrating a state in which the IDC terminal of FIG. 1 is separated from a PCB; and

FIGS. 3A through 3C are perspective views of IDC terminals according to embodiments.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Hereinafter, embodiments will be described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

Also, in the description of the components, terms such as first, second, A, B, (a), (b) or the like may be used herein when describing components of the present disclosure. These terms are used only for the purpose of discriminating one component from another component, and the nature, the sequences, or the orders of the components are not limited by the terms. It should be noted that if one component is described as being “connected,” “coupled,” or “joined” to another component, the former may be directly “connected,” “coupled,” or “joined” to the latter directly or via another component.

A component, which has the same common function as a component included in any one embodiment, will be described by using the same name in other embodiments. Unless disclosed to the contrary, the description of any one embodiment may be applied to other embodiments, and the specific description of the repeated configuration will be omitted.

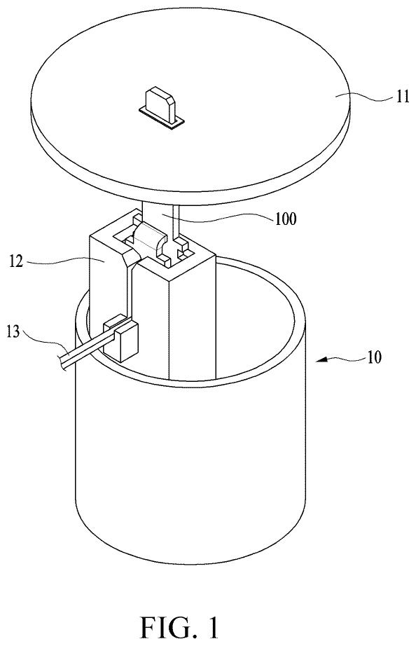

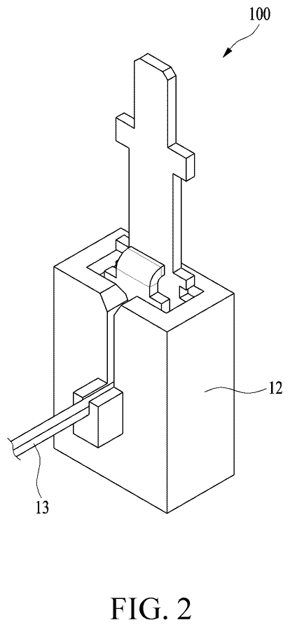

Hereinafter, an insulation displacement contact (IDC) terminal 100 for connection with a magnet wire 13 according to embodiments will be described with reference to FIGS. 1 through 3C. Referring to the drawings, the IDC terminal 100 is provided in an installation target device 10 and electrically connected to the magnet wire 1. In the installation target device 10, a printed circuit board (PCB) 11, and a terminal block 12 for connection with the magnet wire 13 are provided. However, the installation target device 10 and the PCB 11 are for ease of description and are not limited by the drawings.

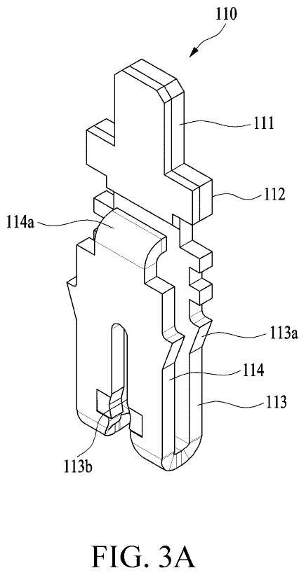

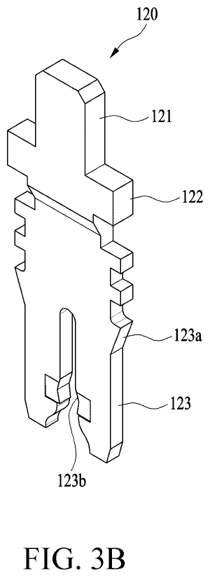

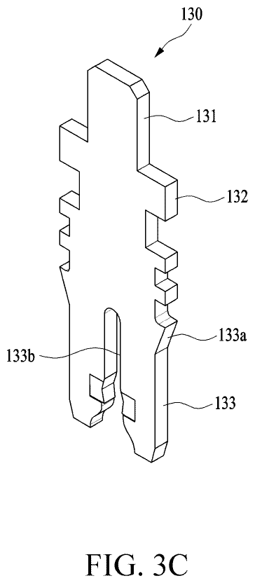

The IDC terminal 100 is coupled to the magnet wire 13 in an IDC manner. More specifically, referring to FIG. 3A, an IDC terminal 110 includes a solder tab 111 mounted on the PCB 11, a solder post 113 inserted into the terminal block 12 and electrically connected to the magnet wire 13, and protrusions 112 protruding from both sides at a boundary portion between the solder tab 111 and the solder post 113. The solder tab 111 is inserted into or penetrates the PCB 11 to be coupled thereto. For example, the IDC terminal 110 penetrates the PCB 11 from a lower surface of the PCB 11 to be coupled thereto, and an end portion of the solder tab 111 exposed through an upper surface of the PCB 11 is soldered to the PCB 11.

The protrusions 112 are formed to protrude outward perpendicularly to the longitudinal direction of the IDC terminal 110 at the boundary portion between the solder tab 111 and the solder post 113. The protrusions 112 are portions that contact the PCB 11 when the solder tab 111 is coupled to the PCB 11. The protrusions 112 restrict a length at which the solder tab 111 is inserted into the PCB 11, and also support the PCB 11 while being in contact with the PCB 11, thereby enabling more stable coupling between the IDC terminal 110 and the PCB 11. According to the present embodiment, since the protrusions 112 are formed on the solder tab 111 of the IDC terminal 110, the IDC terminal 110 may be stably coupled to the PCB 11 as the protrusions 112 contact the PCB 11.

The solder post 113 is inserted into the terminal block 12, electrically connected to the magnet wire 13, and secured to the terminal block 12. The solder post 113 is bent at an end portion thereof to form a bent portion 114. The bent portion 114 is formed to have a length corresponding to that of the solder post 113 and to extend in parallel to the solder post 113. Since the solder post 113 includes the bent portion 114, the solder post 113 may be elastically secured within the terminal block 12 by the inherent elasticity of the bent portion 114.

In addition, a gap of a predetermined distance is formed between the bent portion 114 and the solder post 113, and a stopper 114a is formed at an end portion of the bent portion 114 (i.e., a distal end portion of a portion extending from the bent portion 114 to the solder tab 111) to maintain the gap. For example, the stopper 114a may be formed by bending an end portion of the bent portion 114 toward the solder post 113. In addition, the stopper 114a is formed to have a length corresponding to the gap between the bent portion 114 and the solder post 113. The stopper 114a allows the gap between the solder post 113 and the bent portion 114 to be maintained even when the solder post 113 and the bent portion 114 are deformed by force applied thereto. According to the present embodiment, since the bent portion 114 is formed on the solder post 113, the IDC terminal 110 may be elastically secured to the terminal block 12.

One or more notches 113a are formed on both side edges of the solder post 113. The notches 113a are portions that are coupled and secured to the interior of the terminal block 12. In addition, carriers to be used in the process of manufacturing the IDC terminal 110 may be formed around the notches 113a. At an end portion of the solder post 113, an IDC slot 113b elongated from the end portion of the solder post 113 is formed based on a direction in which the IDC terminal 110 is inserted into the terminal block 12.

The IDC slot 113b is formed in both the solder post 113 and the bent portion 114. The IDC slot 113b is coupled to the as the magnet wire 13 as the magnet wire 13 is received within the terminal block 12. In detail, with the magnet wire 13 inserted into the terminal block 12, the IDC terminal 110 is inserted into the terminal block 12. In this case, the distal end portion of the IDC slot 113b contacts an outer circumferential surface of the magnet wire 13 and cuts an insulating portion of the magnet wire 13, such that the IDC terminal 110 is electrically connected to the magnet wire 13. Further, when the IDC terminal 110 is further inserted into the terminal block 12, the magnet wire 13 is compressed within the IDC slot 113b, such that the IDC terminal 110 is firmly connected to the magnet wire 13.

Meanwhile, FIG. 3B is a view illustrating an IDC terminal 120 according to a modified embodiment. Here, the IDC terminal 120 illustrated in FIG. 3B will be described by assigning reference numerals in the 120 series to the components of the IDC terminal 110 described above and illustrated in FIG. 3A, and a duplicated description thereof will be omitted.

Referring to FIG. 3B, the IDC terminal 120 includes a solder tab 121, protrusions 122, and a solder post 123. The solder tab 121 is coupled to the PCB 11. The protrusions 122 are formed to protrude outward at a boundary portion between the solder tab 121 and the solder post 123, and contact the PCB 11 when the solder tab 121 is coupled to the PCB 11, such that the IDC terminal 120 is stably coupled to the PCB 11.

Unlike the embodiment described above, the solder post 123 according to the present embodiment does not include a bent portion and is formed in a plate shape. In addition, the solder post 123 is formed to have a thickness less than that of the solder tab 121. Due to the thickness difference between the solder tab 121 and the solder post 123, an inclined surface is formed in a boundary region between the solder tab 121 and the solder post 123. According to the present embodiment, by forming the solder post 123 to have a thickness less than that of the solder tab 121, the thickness of a portion inserted into the terminal block 12 may be reduced, such that a coupling portion between the IDC terminal 120 and the magnet wire 13 may be slimmer.

FIG. 3C is a view illustrating an IDC terminal 130 according to another modified embodiment. The IDC terminal 130 illustrated in FIG. 3C will be described by assigning reference numerals in the 130 series to the components of the IDC terminal 110 described above and illustrated in FIG. 3A, and a duplicated description thereof will be omitted. Referring to FIG. 3C, the IDC terminal 130 includes a solder tab 131, protrusions 132, and a solder post 133.

The solder tab 131 is coupled to the PCB 11. According to the embodiment illustrated in FIG. 3C, since the thickness of the solder tab 131 is also reduced, the cross-sectional area of a hole in a coupling portion between the solder tab 131 and the PCB 11 may also be reduced.

The protrusions 132 are formed to protrude outward at a boundary portion between the solder tab 131 and the solder post 133, and contact the PCB 11 when the solder tab 131 is coupled to the PCB 11, such that the IDC terminal 130 is stably coupled to the PCB 11.

Unlike the embodiments described above, the solder post 133 according to the present embodiment does not include a bent portion and is formed in a plate shape, and the solder post 133 and the solder tab 131 are formed to have the same thickness. As a result, an additional process for forming the solder tab 131 and the solder post 133 may be unnecessary, and accordingly, manufacturing costs may be reduced.

According to the present embodiment, by forming the solder post 133 and the solder tab 131 to have the same thickness, the thickness of a portion inserted into the terminal block 12 may be reduced, such that a coupling portion between the IDC terminal 130 and the magnet wire 13 may be slimmer.

While the embodiments have been described with reference to the limited drawings, it will be apparent to one of ordinary skill in the art that various alterations and modifications can be made from the above description. For example, suitable results may be achieved if the described techniques are performed in a different order, and/or if components in a described system, structure, device, or circuit are combined in a different manner, and/or replaced or supplemented by other components or their equivalents.

Therefore, other implementations, other embodiments, and equivalents to the claims are also within the scope of the following claims.

1. An insulation displacement contact (IDC) terminal for electrical connection with a magnet wire, comprising:
a solder tab coupled to a printed circuit board (PCB) of an installation target device;
a solder post inserted into a terminal block for coupling the magnet wire, including:
an IDC slot adapted to be coupled to the magnet wire along a direction in which the IDC terminal is inserted into the terminal block; and
a plurality of notches formed on side portions of a region adjacent to the protrusion to be secured to an inner surface of the terminal block; and
a protrusion formed to protrude outward at a boundary portion between the solder tab and the solder post.

2. The IDC terminal of claim 1, wherein the solder post defines a bent portion having a length corresponding to a length at which the solder post is inserted into the terminal block.

3. The IDC terminal of claim 2, wherein a gap of a predetermined distance is formed between the solder post and the bent portion.

4. The IDC terminal of claim 3, wherein and a stopper is formed at an end portion of the bent portion to maintain the gap.

5. The IDC terminal of claim 4, wherein the stopper is formed to be bent at the end portion of the bent portion toward the solder post.

6. The IDC terminal of claim 5, wherein and a bending length of the stopper is less than or equal to the distance of the gap.

7. The IDC terminal of claim 2, wherein the solder post is formed to have a thickness less than a thickness of the solder tab.

8. The IDC terminal of claim 7, wherein the solder post and the bent portion have a same thickness.

9. The IDC terminal of claim 1, wherein the solder post is formed in a plate shape.

10. The IDC terminal of claim 9, wherein the solder post has a thickness less than a thickness of the solder tab.

11. The IDC terminal of claim 10, wherein a boundary region between the solder post and the solder tab is formed with an inclined surface.

12. The IDC terminal of claim 9, wherein the solder post and the solder tab have a same thickness.

13. An insulation displacement contact (IDC) terminal, comprising:
a solder tab adapted to be coupled to a printed circuit board (PCB) of an installation target device;
a solder post inserted into a terminal block and adapted to be coupled to a magnet wire, including:
an IDC slot adapted to be coupled to the magnet wire along a direction in which the IDC terminal is inserted into the terminal block; and
a plurality of notches formed on side portions of a region adjacent to the protrusion to be secured to an inner surface of the terminal block; and
a protrusion extending outward at a boundary portion between the solder tab and the solder post.

14. The IDC terminal of claim 13, wherein the solder post defines a bent portion having a length corresponding to a length at which the solder post is inserted into the terminal block.

15. The IDC terminal of claim 14, wherein a gap of a predetermined distance is formed between the solder post and the bent portion, and a stopper is formed at an end portion of the bent portion to maintain the gap.

16. The IDC terminal of claim 15, wherein the stopper is bent at the end portion of the bent portion toward the solder post.

17. The IDC terminal of claim 16, wherein and a bending length of the stopper is less than or equal to the distance of the gap.

18. The IDC terminal of claim 13, wherein the solder post has a thickness less than a thickness of the solder tab.

19. The IDC terminal of claim 13, wherein a boundary region between the solder post and the solder tab defines an inclined surface.

20. An insulation displacement contact (IDC) terminal assembly, comprising:
a printed circuit board (PCB); and
an IDC contact, including:
a solder tab coupled to the PCB;
a solder post inserted into a terminal block for coupling to a magnet wire, including:
an IDC slot adapted to be coupled to the magnet wire along a direction in which the IDC terminal is inserted into the terminal block; and
a plurality of notches formed on side portions of a region adjacent to the protrusion to be secured to an inner surface of the terminal block; and
a protrusion formed to protrude outward at a boundary portion between the solder tab and the solder post.
